(19) United States
(12) Patent Application Publication
(10) Pub. No.: US 2018/0037476 A1
(43) Pub. Date: Feb. 8, 2018

(54) FIELD ADJUSTABLE FOG TO SOLID CAPACITY GREASE INTERCEPTOR

(71) Applicant: Schier Products Company, Edwardsville, KS (US)

(72) Inventors: Benjamin F. Brown, Overland Park, KS (US); Todd E. Uhlenhake, Overland Park, KS (US); Martin B. Ismert, Prairie Village, KS (US); Kenneth James Loucks, Vancouver, WA (US); Charles M. Ismert, Kansas City, MO (US); Luke J. Ismert, Prairie Village, KS (US)

(21) Appl. No.: 15/226,693

(22) Filed: Aug. 2, 2016

(51) Int. Cl. C02F 1/40; B01D 21/24; B01D 21/00

(52) U.S. Cl. CPC C02F 1/40; B01D 21/0003; B01D 21/2405; B01D 21/2444; B01D 21/245; C02F 2201/002

(57) ABSTRACT

A field-adjustable separation device including a base and a sidewall cooperatively defining a separation compartment. The device includes an inlet conduit attached to a first portion of the sidewall and an outlet conduit having a first segment including a distal end of the outlet conduit removably attached to a second portion of the sidewall substantially opposite the first portion. The outlet conduit also has a second segment fluidly interposed between the first segment and the separation compartment. The second segment includes a sectioned portion defining a plurality of pre-determined locations spaced along the second segment. The first segment is in fluid communication with an exterior of the separation compartment. The second segment is configured for adjustment to define an outlet orifice according to the plurality of pre-determined locations to provide fluid communication between the first segment and the separation compartment. The adjustment alternatively presents the outlet orifice at a different distance from the distal end for each of the plurality of pre-determined locations, as measured along a vertical axis.

### BACKGROUND OF THE INVENTION

### 1. Field of the Invention

The present inventive concepts relate to systems and devices for treating flowable streams including one or more liquid component(s). The present inventive concepts more particularly relate to an improved device having an adjustable conduit for transporting streams from a separation compartment of a treatment system and/or the device.

### 2. Discussion of Related Art

Effluent separation devices for separating water from solids, greases and the like are often designed to perform much of the separation process as the stream flows through a separation compartment. Effluent flow is commonly delivered to the separation compartment by an input conduit, and transported from the separation compartment by an output conduit. For example, an advanced effluent treatment device is provided in U.S. Pat. No. 7,481,321, which is hereby incorporated herein by reference. Inlet and outlet conduits of the '321 Patent are connected to a separation compartment adjacent an aperture in the sidewall of the chamber using a coupling that extends through the aperture, illustrated in the figures. The inlet and outlet conduits fluidly communicate with the interior of the separation compartment at apertures in vertical segments of the conduits.

Maintenance of separation devices such as that described in the '321 Patent is required on a periodic basis to prevent operation in a bypass condition, i,e., in a condition in which effective separation is prevented by accumulation of waste layers beyond acceptable levels.

However, current methodologies such as these may lead to unnecessarily frequent maintenance and/or increased incidents of bypass failures. There is thus a need for an improved apparatus and method for maintaining separation devices.

This background discussion is intended to provide information related to the present inventive concepts which is not necessarily prior art.

### SUMMARY

Embodiments of the present inventive concepts address one or more of the above-described and other problems and limitations by providing improved conduit structures for a flowable stream treatment system, or device.

According to one aspect of the present inventive concepts, a field-adjustable separation device is provided. The device has a base and a sidewall cooperatively defining a separation compartment. The device also includes an inlet conduit attached to a first portion of the sidewall and an, outlet conduit having a first segment including a distal end of the outlet conduit removably attached to a second portion of the sidewall substantially opposite the first portion. The outlet conduit also has a second segment fluidly interposed between the first segment and the separation compartment. The second segment includes a sectioned portion defining a plurality of pre-determined locations spaced along the second segment. The first segment is in fluid communication with an exterior of the separation compartment. The second segment is configured for adjustment to define an outlet orifice according to the plurality of pre-determined locations to provide fluid communication between the first segment and the separation compartment. The adjustment alternatively presents the outlet orifice at a different distance from the distal end for each of the plurality of pre-determined locations, as measured along a vertical axis.

A second aspect of the present inventive concepts concerns a method for field adjustment of a separation device. The device has a base and a sidewall cooperatively defining a separation compartment and an inlet conduit attached to a first portion of the sidewall. The method may include removing an outlet conduit of the device. The outlet conduit has a first segment including a distal end of the outlet conduit configured for removable attachment to a second portion of the sidewall substantially opposite the first portion. The outlet conduit also has a second, segment fluidly interposed between the first segment and the separation compartment. The second segment includes a sectioned portion defining a plurality of pre-determined locations spaced along the second segment. The second segment is configured for adjustment to define an outlet orifice according to the plurality of pre-determined locations to provide fluid communication between the first segment and the separation compartment. The method may also include adjusting the second segment to define the outlet orifice according to a first location of the plurality of pre-determined locations, the outlet orifice being thus defined at a first distance along a vertical axis from the distal end of the outlet conduit. The method may also include reattaching the distal end of the adjusted outlet conduit to the second portion of the sidewall.

A third aspect of the present inventive concepts concerns a field-adjustable outlet conduit for use with a separation device having a base and a sidewall cooperatively defining a separation compartment. The outlet conduit includes a first segment including a distal end of the outlet conduit configured to be removably attached to the sidewall. The outlet conduit also includes a second segment configured to be fluidly interposed between the first segment and the separation compartment. The second segment has a sectioned portion defining a plurality of pre-determined locations spaced along the second segment. The first segment is configured for fluid communication with an exterior of the separation compartment. The second segment is configured for adjustment to define an outlet orifice according to the plurality of pre-determined locations to provide fluid communication between the first segment and the separation compartment. The adjustment alternatively presents the outlet orifice at a different distance from the distal end for each of the plurality of pre-determined locations, as measured along a vertical axis in an assembled configuration of the separation device.

This summary is provided to introduce a selection of concepts in a simplified form. These concepts are further described below in the detailed description of the preferred embodiments.

This summary is not necessarily intended to identify key features or essential features of the claimed subject matter, nor is it intended to be used to limit the scope of the claimed subject matter.

Various other aspects and advantages of the present inventive concepts will be apparent from the following detailed description of the preferred embodiments and the accompanying drawing figures.

### BRIEF DESCRIPTION OF THE DRAWING FIGURES

Preferred embodiments of the present inventive concepts are described in detail below with reference to the attached drawing figures, wherein:

Figure (FIG.) 1 is a partial, cross-sectional side view of a disassembled separation device constructed in accordance with an embodiment of the present inventive concepts;

FIG. 2 is an bottom side perspective view of the outlet conduit of FIG. 1 without an end piece;

FIG. 3 is an elevated side perspective view of the outlet conduit of FIG. 1 following adjustment for enhanced bottom layer capacity;

FIG. 4 is a partial, cross-sectional side view of the device of FIG. 1 with a snout of the outlet conduit assembled to a saddle fixed to a sidewall and an inlet conduit shown detached from the device;

FIG. 5 is a schematic diagram illustrating a separation device in early stages of an operational period;

FIG. 6 is a schematic diagram of the device of FIG. 5 in advanced stages of an operational period and just prior to development of a bypass condition;

FIG. 7 is a schematic diagram of the device of FIG. 5 in a bypass condition; and

FIG. 8 is a schematic diagram illustrating a separation device in advanced stages of an operational period and just prior to development of a bypass condition, the device having been adjusted to enhance a capacity for a bottom layer and reduce a capacity for a top layer as compared with the device of FIG. 5.

The drawing figures do not limit the present inventive concepts to the specific embodiments disclosed and described herein. The drawings are not necessarily to scale, emphasis instead being placed upon clearly illustrating the principles of the preferred embodiments.

### DETAILED DESCRIPTION OF THE PREFERRED EMBODIMENTS

The present inventive concepts are susceptible of embodiment in many different forms. While the drawings illustrate, and the specification describes, certain preferred embodiments of the invention, it is to be understood that such disclosure is by way of example only. There is no intent to limit the principles of the present inventive concepts to the particular disclosed embodiments.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present inventive concepts can include a variety of combinations and/or integrations of the embodiments described herein.

FIG. 1 illustrates a separation device 10 that may be used for treating an effluent stream. Generally speaking, device 10 is configured as a hydromechanical grease interceptor. However, it is foreseen that the teachings of the present disclosure may be applicable to related devices, such as gravity grease interceptors, without departing from the spirit of the present inventive concept.

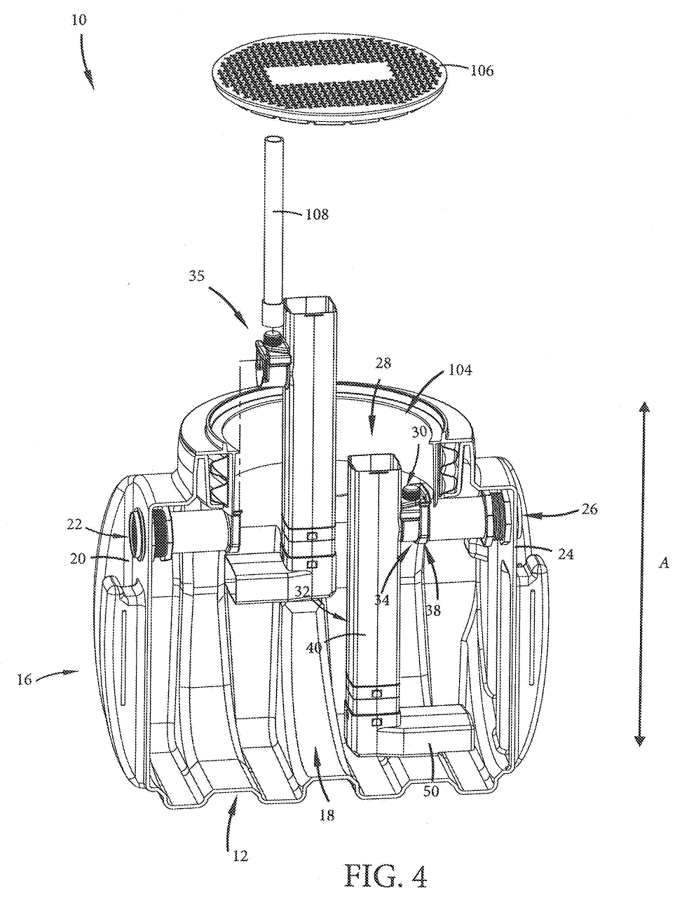

The separation device 10 is generally characterized as a container having a base 12, opposing ceiling portion 14, and a sidewall 16 that extends upwardly from the base 12 to the ceiling portion 14. The base 12, ceiling portion 14 and sidewall 16 cooperatively define a separation compartment 18 in the interior of the device 10. Sidewall 16 comprises a first sidewall portion 20 having an inlet aperture 22 extending therethrough to enable inlet fluid communication between the separation compartment 18 and its exterior. Sidewall 16 also comprises a substantially opposing second sidewall portion 24 that includes an outlet aperture 26 extending therethrough to enable outlet fluid communication between the exterior and the separation compartment 18. Device 10 also includes an inlet conduit (35, see FIG. 4) and an outlet conduit 28 configured, respectively, to convey the inlet and outlet effluent flow to and from the separation compartment 18.

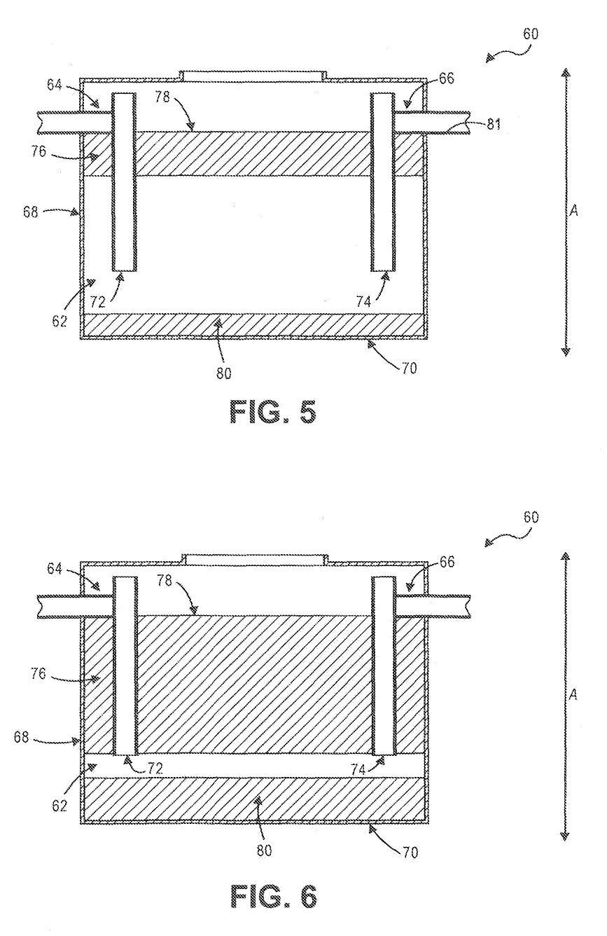

The device 10 is configured to be installed in a generally upright orientation, preferably below grade. The sidewall 16 extends upwardly from the base 12 to the ceiling portion 14 in a direction that, in a preferred embodiment, is generally parallel to a vertical (i.e., plumb) axis A. Following installation, the effluent stream flows from art effluent source (not shown), through the inlet aperture 22, across the separation compartment 18 and out through the outlet aperture 26, and is ultimately communicated to an effluent drain such as a sewer (not shown). A gravity separation process occurs during the effluent stream's progression across the separation compartment 18. In the separation process one or more light components of the effluent buoyantly migrate to a top layer near the water line as described in more detail below. One or more heavy components of the effluent sink to a bottom layer adjacent the base 12. (See FIGS. 5-8)

The device 10 offers several advantages over existing technology. Conventional separation containers are constructed according to pre-determined ratings and capacities which may be used to guide customers toward suitable models for their intended uses. These ratings and capacities are based, at least in part, on the average rates at which the aforementioned top and bottom layers are expected to accumulate according to various use categories. The typical consumer must therefore predict or obtain predictions for (or rely on published standards or parameters for) the average accumulation rates that are experienced in their category(ies) of intended use in order to choose an appropriate model. But the composition of effluent streams can vary greatly across sources—even within a single use category—and/or across time at a given source, making such predictions inherently unreliable. Nonetheless, contemporary technology fails to effectively address the shortcomings of relying exclusively on such prediction-based methods and systems.

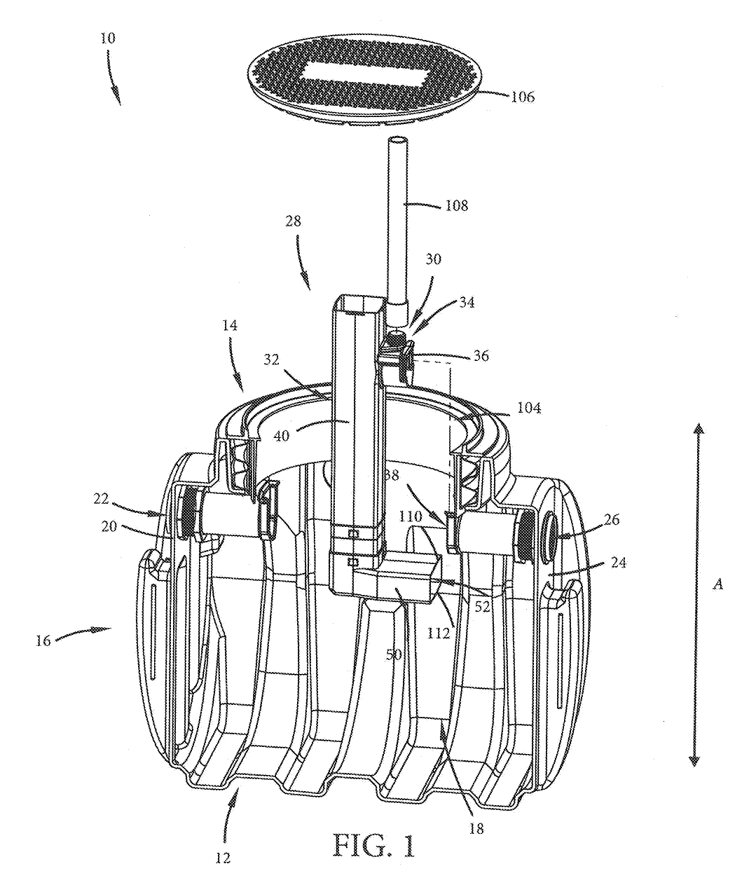

Embodiments of the present inventive concept include field-adjustable conduits permitting customization of separation devices to, for example, conform top and/or bottom layer capacities of the compartment to the onsite conditions experienced at a customer location. The embodiments exemplified in FIGS. 1 and 2 include an adjustable outlet conduit 28. The inlet conduit (see FIG. 4) is preferably of similar construction to the outlet conduit 28, and therefore for the sake of brevity the outlet conduit 28 is described in more detail herein with the understanding that such teachings are also applicable to the inlet conduit.

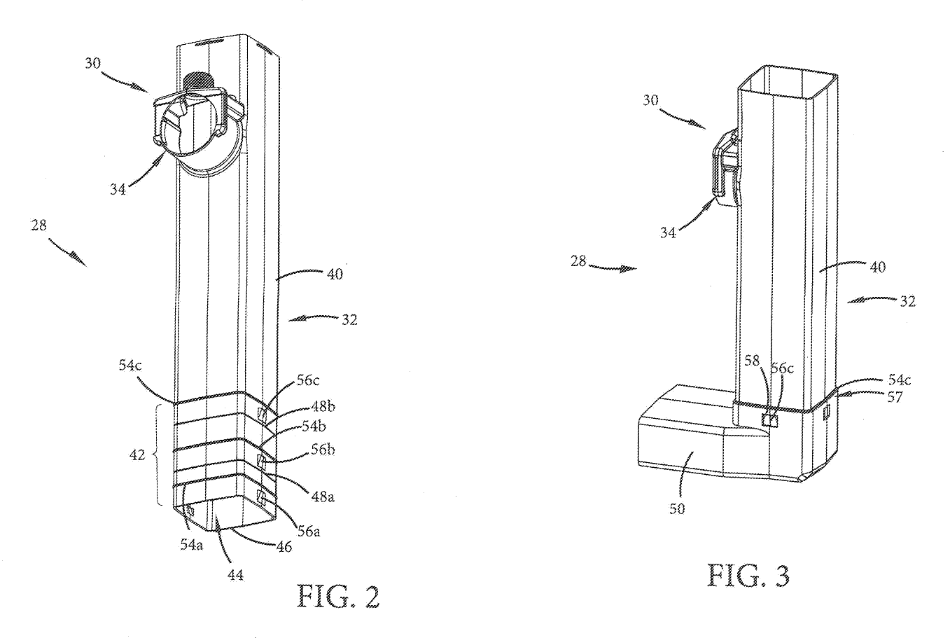

As shown in FIGS. 2 and 3, outlet conduit 28 includes a first segment 30 and a second segment 32. First segment 30 includes a distal end 34 of the outlet conduit 28. Distal end 34 is configured to be removably attached to the second sidewall portion 24 to facilitate field adjustments. Removable attachment of the outlet conduit 28 to the second sidewall portion 24 may be achieved by a variety of structures without departing from the spirit of the present inventive concepts. (See, e.g., the '321 Patent)

Turning briefly to FIG. 4, the device of FIG. 1 is shown with outlet conduit 28 removably coupled to second sidewall portion 24. FIG. 4 also shows an inlet conduit 35 decoupled from the first sidewall portion 20. Inlet conduit 35 is of substantially identical construction to outlet conduit 28, though it is again noted that it may be of different construction in other embodiments without departing from the spirit of the present inventive concepts.

Returning to description of the attachment between the outlet conduit 28 and the second sidewall portion 24, the distal end 34 of the outlet conduit 28 is removably or detachably coupled to a receiver fixed to the second sidewall portion 24. More specifically, the distal end 34 includes a snout 36 (see FIG. 1) detachably coupled to a saddle 38, in accordance with co-pending U.S. patent application Ser. No. 15/085,852, filed Mar. 30, 2016, and entitled QUICK DISCONNECT CONDUIT JOINT, which is hereby incorporated herein by reference in its entirety. Saddle 38 is preferably fixed relative to sidewall 16. Inlet conduit 35 is preferably mounted to first sidewall portion 20 in a similar fashion.

When engaged with the sidewall, second segment 32 is fluidly interposed between first segment 30 and separation compartment 18, as shown in FIG. 4. Second segment 32 includes a stem 40. Stem 40 has a sectioned portion 42 near a proximal end of the of conduit 28, as shown in FIG. 2. The sectioned portion 42 includes projections and/or indentations along an outer surface of the stem 40 defining a plurality of segments. The projections and/or indentations preferably also define a plurality of pre-determined locations spaced along the stem 40. Each of the plurality of pre-determined locations corresponds to a position at which an outlet orifice may be selectively defined. The outlet orifice is the proximal terminus of the outlet conduit 28 in an assembled configuration and provides fluid communication between the first segment 30 and the separation compartment 18.

In the embodiment of FIG. 2, outlet orifice 44 may be selectively defined according to bottom edge 46 and indentations 48a, 48b, together comprising the plurality of pre-determined locations. The outlet orifice 44 may initially be defined by bottom edge 46 at the proximal end of the outlet conduit 28 (i.e., a first location or distance between the outlet orifice 44 and the distal end 34 of the outlet conduit 28). Where successively greater capacities are desired for containing a bottom waste layer (e.g., a solids layer) in the device 10, the stem 40 may be severed along, indentations 48a, 48b of the sectioned portion 42, in each case to present a new bottom edge and a relocated outlet orifice 44 (i.e., a second location or distance between the outlet orifice 44 and the distal end 34 of the outlet conduit 28). For example, cutting along indentation 48a and removing the severed segment effectively shortens the distance—as measured along vertical axis A—between the outlet orifice 44 and the distal end 34 of the outlet conduit 28. This results in a lesser capacity for a top waste layer and a greater capacity for a bottom waste layer of the device 10. Further or alternatively cutting along indentation 48b results in an even shorter (i.e., third) distance between the outlet orifice 44 and the distal end 34, which in turn yields the least top waste layer capacity and the greatest bottom waste layer capacity.

As illustrated in FIG. 3, outlet conduit 28 may also be configured to include a diffuser-type end piece 50 defining outlet orifice 52 The plurality of pre-determined locations of outlet conduit 28 may in such embodiments be defined by projections or collars 54 and seating strictures including tabs 56 that extend from the outer surface of the sectioned portion 42, as shown in FIG. 2. Collars 54 and tabs 56 are spaced along the outer surface of sectioned portion 42 at positions corresponding to bottom edge 46 and indentations 48. The end piece 50 includes a mating structure having a slot 58 sized for receiving one or more of tabs 56.

End piece 50 may be adjusted along the sectioned portion 42 and matched to a desired pre-determined location. Slot 58 may then be received by the corresponding tab 56 for removable attachment of the end piece 50 to the stem 40. Optionally, such attachment may be facilitated by cutting along one or more of the indentations 48, and removing the severed segment. For instance, attaching end piece 50 to the stem 40 at a pre-determined location defined by collar 54c and tab 56c, as shown in FIG. 3, may include cutting along indentation 48b to remove the remainder of the stem 40 below indentation 48b. Preferably, an upper segment 57 of the end piece 50 will slide snugly over the new proximal terminus of the stem 40 until slot 58 receives tab 56c, In addition, collar 54c preferably extends outward beyond an inner surface of the upper segment 57 of the end piece 50, thereby preventing further upward movement of the end piece 50 along the stem 40 beyond collar 54c.

It is foreseen that other seating and mating structures may be utilized for removably securing end pieces to stems without departing from the spirit of the present inventive concepts. For example, collars may doubly serve as seating structures, permitting omission of tabs or the like. The collars may substantially circumscribe the outer surface of the sectioned portion 42 as shown in the illustrated embodiments, or the collars may be discontinuous, without departing from the spirit of the present in concepts. Mating structures may comprise hollows and/or channels formed in the inner surface of the upper segment of the end piece that are configured to snap over and form an interference fit with the collars. The collars may also comprise gaskets such as o-rings or the like for sealingly mating with the end piece.

Other exemplary seating and mating structures may include, respectively, a hole extending through the stem that is matched to a hole extending through the end piece. The holes may be configured such that a fastener such as a screw or pin may be extended therethrough to fix the end piece to the stem. This embodiment preferably includes collars that define a plurality of pre-determined locations.

In still other embodiments, an outlet conduit may be provided including a stem having a substantially cylindrical sectioned portion with a helical or similar thread formed along an outer surface. An end piece having a substantially cylindrical upper segment may be formed with a corresponding thread along an inner surface of the upper segment. A plurality of indentations and/or projections in the outer surface of the sectioned portion of the stem may define the plurality of pre-determined locations. In this manner, the end piece may be rotated and continuously threaded along the sectioned portion of the stem until reaching a desired pre-determined location along the stem. Moreover, the plurality of indentations and/or projections preferably mate with corresponding indentations and/or projections in the inner surface of the upper segment of the end piece to fix the position of the end piece along the stem at the desired location. However, it is foreseen that other devices (such as the aforementioned fasteners) or surface conformations may be used to fix the location of the end piece along the stem without departing from the spirit of the present inventive concept. Alternatively or in addition, the friction resulting from threading the end piece along the stem may be sufficient to prevent undesired movement of the end piece along the stem, particularly where thread seal tapes or the like are employed.

In this manner, the outlet conduit 28 may be adjusted in the field and customized to the needs of a specific customer based, for example, during live onsite testing to determine the output composition of a specific effluent source. For instance, the outlet conduit 28 may be adjusted to define an outlet orifice 44 and/or 52 according to the plurality of pre-determined locations spaced along sectioned portion 42 to provide fluid communication between the first segment 30 and the separation compartment 18. The adjustable outlet orifice 44 and/or 52 is thereby alternatively presented at a different distance, as measured along vertical axis A, from the distal end 34 for each of the plurality of pre-determined locations.

It should be reiterated here that the inlet conduit is preferably constructed according to the teachings set forth herein for constructing an outlet conduit. The inlet conduit would preferably be assembled in the device in a reverse horizontal orientation, as shown in FIG. 4, with respect to the outlet conduit and attached to the first sidewall portion rather than the second sidewall portion. Further, the inlet conduit and outlet conduit are preferably of substantially similar overall length and composition, being removably attached to the sidewall at substantially similar elevations or positions along vertical axis A. The plurality of pre-determined locations of the inlet conduit also preferably substantially correspond to the plurality of pre-determined locations of the outlet conduit. In this manner, following adjustment respectively of the inlet orifice and the outlet orifice of the inlet and outlet conduits to new pre-determined locations and reattachment of the conduits to the sidewall, the inlet orifice and the outlet orifice are presented at substantially similar elevations.

Turning to FIGS. 5-7, simplified schematic illustrations of a separation device 60 are provided to support discussion of the operation of exemplary embodiments of the present inventive concepts. The device 60 includes a separation compartment 62, an inlet 64 and an outlet 66. The separation compartment 62 is defined by a sidewall 68 and a base 70 and is configured for containing the mixture during a separation process. More specifically, the effluent mixture flows from an effluent source, through the inlet 64, through an inlet orifice 72 into the separation tank. The effluent mixture travels across the separation compartment 62, through an outlet orifice 74, and out through the outlet 66 to be ultimately communicated to an effluent drain such as a sewer (not pictured). A gravity separation process occurs during the effluent mixture's progression across the separation compartment 62 from the inlet 64 to the outlet 66. In the separation process one or more light components buoyantly migrate to a top layer 76 near a static water line 78. One or more heavy components sink to a bottom layer 80 adjacent the base 70.

The separation device 60 commonly operates in cycles including both dynamic cleaning/start-up and quasi-steady or steady-state operational periods. Of course, backup/failure and other states may also occur, as will be discussed in more detail below. During a typical startup process, the water line in the separation compartment 62 rises as effluent mixture is added via the inlet conduit 34, until the water line 78 substantially levels with a low surface 81 of the outlet 66. (See FIG. 5) Such a sustained water line level during “normal” or operational periods is otherwise known to those of ordinary skill to be approximated by and referred to as the “static water line,” as used herein.

Subsequently, during normal operational periods, top layer 76 and/or bottom layer 80 may thicken within the separation compartment 62 as light components and heavy components are respectively retained in, these layers. FIG. 5 illustrates exemplary thicknesses for the top layer 76 and bottom layer 80 following startup. FIG. 6 illustrates exemplary thicknesses for the top layer 76 and bottom layer 80 after some period of normal operation during which the top layer 76 and bottom layer 80 respectively thicken at rates approximately equal to those expected by the designer. The device 60 of FIG. 6 has maintained one or more sufficiently lengthy normal operational period(s) to accumulate nearly its limit for separation of light and heavy components. Put another way, if additional light and/or heavy components separate from the effluent steam and attempt to join the top layer 76 or bottom layer 80, such layer(s) will likely thicken still more and may create a bypass condition. However, because a relatively minor proportion of the separation compartment 62 remains unused by either the top or bottom layers 76, 80, it may be said that the device 60 of FIG. 6 is reasonably optimized for normal operation with the particular effluent source (not shown) feeding it.

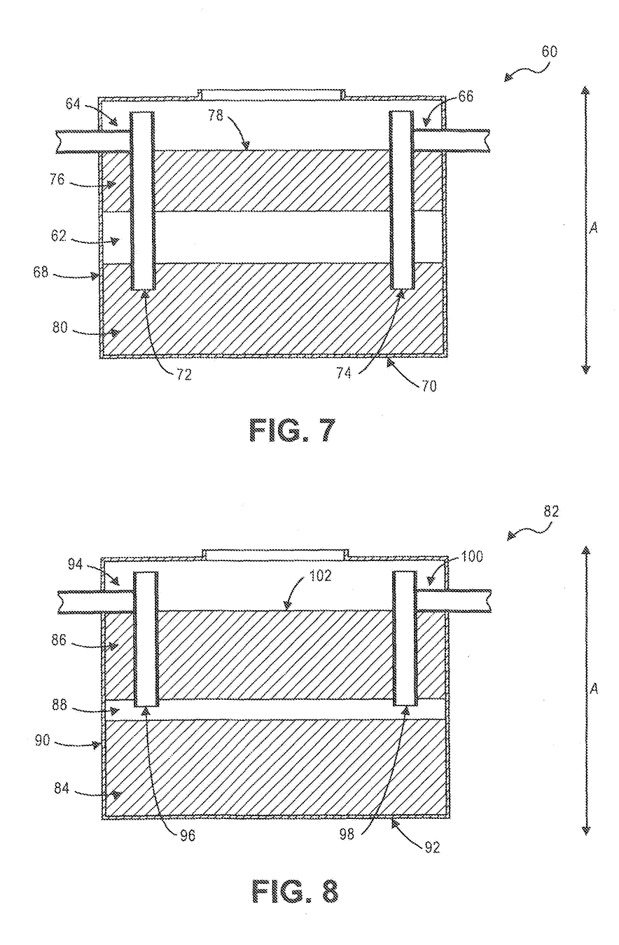

A bypass condition leads to a failure to separate out light and/or heavy components from the effluent stream in the separation compartment 62. FIG. 7 illustrates a device 60 in a bypass condition resulting from the high level of the bottom layer 80. It may be appreciated from review of FIG. 7—and in particular of the positions of orifices 72, 74 relative to the boundaries of layers 76, 80 along a vertical axis A—that the normal operational period(s) which preceded the bypass condition generated a higher rate of bottom layer 80 thickening and a lower rate of top layer 76 thickening than was anticipated. As such, a bypass condition was reached prematurely; that is, there is a relatively significant proportion of the separation compartment 62 not used or occupied by either of layers 76, 80. The device 60 must therefore be serviced earlier (and more frequently) than would be the case if the device 60 was optimally configured for use with the particular effluent source (not shown) and, more specifically, with the particular effluent stream and its relative content composition.

Turning now to FIG. 8, a device 82 is illustrated that has been adjusted for greater bottom layer capacity, in accordance with the concepts of the invention, and lesser top layer capacity as compared to the device of FIG. 6 (assuming similar scaling and dimensions). Such embodiments may be used to treat an effluent mixture having a higher content of bottom layer 84 components (e.g., solids) per content top layer 86 components. The device 82 includes a separation compartment 88, an inlet 94 and an outlet 100. The separation compartment 88 is defined by a sidewall 90 and a base 92. The effluent mixture flows from an effluent source, through an inlet 94, through an inlet orifice 96, across the separation compartment 88, through an outlet orifice 98, and out through an outlet 100 to be ultimately communicated to an effluent drain such as a sewer (not pictured). A gravity separation process occurs during the effluent mixture's progression across the separation compartment 88 from the inlet 94 to the outlet 100. In the separation process one or more light components buoyantly migrate to top layer 86 near a static water line 102. One or more heavy components sink to bottom layer 84 adjacent the base 92. As illustrated, the distance of the inlet orifice 96 has been adjusted as described herein to raise the position of the orifice 96 in the chamber 88. The distance of the outlet orifice 98 has been likewise adjusted.

Accordingly, the invention is also concerned with methods for field adjustment of a separation device. According to the principles described above, the exemplary device 10 of FIG. 1 accumulates materials in top and/or bottom waste layers (not shown) deposited by an effluent stream during segments of normal operation. After a pre-determined period of time—preferably after permitting the device 10 to operate up to the point of a bypass condition—maintenance on the device 10 may be conducted to remove the top and/or bottom layers. The separation compartment 18 may be accessed through an access port 104, which may be covered by a lid 106 when not in use. A maintenance provider may manually engage via lift-rod 108 and lift outlet conduit 28 from a snap-fit connection with saddle 38 and remove it front the separation device 10.

The maintenance provider should observe the relative levels of accumulated top and bottom layers in relation to the location of outlet orifice 52 prior to cleaning out the waste layers for maintenance purposes. These observations over a number of operational/maintenance cycles may permit the maintenance provider to determine an average content for the bottom layer components (e.g., solids) per content top layer components (e.g., greases and the like).

The aforementioned calculated average ratio (or similar calculated properties of the effluent stream) may permit the maintenance provider to determine an optimal or near-optimal adjustment for the outlet orifice 52 to reduce the amount of unused separation compartment 18 space at the point during operational periods just prior to reaching a bypass condition. These values or parameters may be unique to the particular effluent source from which the device 10 receives the effluent mixture, and thus may be determined on a case-by-case basis through the observations described above.

It is foreseen that a maintenance provider may also have sufficient information on hand regarding the average composition of the effluent mixture to enable determination of optimized orifice positions without the need for experimental observation, without departing from the spirit of the present inventive concepts. It is foreseen that documentation may indicate useful pre-determined ratio values corresponding to the pre-determined locations along sectioned portion 42 of the outlet conduit (and, corresponding pre-determined locations along a sectioned portion of the inlet conduit) to help guide the maintenance provider. For instance, with reference to FIG. 2, projections 54a, 54b, 54c may respectively be associated with 70:30, 60:40, and 50:50 light:heavy ratios and the maintenance provider may rely on these documented relationships when adjusting the outlet conduit 28 (and inlet conduit, if desired). Based on the aforementioned observations and/or review of documentation, a pre-determined location along the sectioned portion 42 may be chosen.

To adjust the outlet orifice 52 of the outlet conduit 28 according to the selected pre-determined location, the maintenance provider may remove the lid 106. The maintenance provider may detach the outlet conduit 28 from the sidewall 16, for instance by using a lift rod 108 to engage the outlet conduit 28 and lift the outlet conduit 28 from a snap-fit with saddle 38.

In embodiments where end piece 50 is employed, the maintenance provider may remove the end piece(s) 50. The maintenance provider may then cut along the indentation 48 corresponding to the selected pre-determined location using an appropriate tool such as a hack saw or the like, and remove the severed segment from the outlet conduit 28. Where the end piece 50 is employed, the end piece may be reinstalled by engaging the stem 40 until matched and aligned to the tab 56 corresponding to the selected pre-determined location. The slot 58 may then be received by the selected tab 56 to detachably couple the end piece 50 to the stem 40. The outlet conduit 28 may be reattached at distal end 34 to the second portion of the side wall 20. It will be appreciated that the adjusted outlet conduit 28 now comprises an outlet orifice 44/52, wherein the initial distance as measured from the edge of the orifice 44/52 to the distal end 34 of the conduit 28 has been decreased. In other words, once re-positioned in the compartment 18, the position of the edge of the outlet orifice 44/52 will have been raised, relative to the solids level (not shown) in the compartment 18, for greater bottom layer capacity in the device.

As referenced above, the inlet conduit (not shown) is preferably adjusted in substantially the same way as the outlet conduit 28 such that the inlet orifice and the outlet orifice are positioned at substantially the same elevation along the vertical axis A once the device 10 is reassembled following adjustment.

It should be noted that the choice of orifice shape and/or number may result in varying design considerations for implementing the present inventive concepts. For example, the simplified inlets and outlets of FIGS. 5-8 present orifice pairs 72, 74 and 96, 98 defined along substantially horizontal planes, thereby presenting a very thin profile for each orifice along vertical axis A that may permit a maximum degree of useable space in the separation compartments 62, 88. However, diffuser-style end pieces 50 may define one or more orifices with upper and lower surfaces presented at different positions along vertical axis A in an assembled device 10. In such cases, it is preferable to determine the desired new position(s) for outlet orifice 52, for example, by taking into account an uppermost edge 110 and a lowermost edge 112 of the orifice 52. More particularly, the desired new position for outlet orifice 52 should be determined by taking into account a relationship of the bottom boundary of the top layer of waste to the uppermost edge 110 as well as a relationship of the top boundary of the bottom layer of waste to the lowermost edge 112. In a similar manner, multiple orifice conduits may also be adjusted according to their uppermost and lowermost edges and, respectively, their relationships to the boundaries of the top and bottom waste layers.

Although the above description presents features of preferred embodiments of the present inventive concepts, other preferred embodiments may also be created in keeping with the principles of the invention. Furthermore, these other preferred embodiments may in some instances be realized through a combination of features compatible for use together despite having been presented independently in the above description.

The general shapes of the components of the separation device, for instance its bottom, top and side wall and the shape of the pipes or other segments comprising the conduits, may vary without departing from the spirit of the present inventive concepts. The upper and second segments of the conduits described herein may be “joined” by being fixed to one another or by being formed in an integral piece without, departing from the spirit of the present inventive concept. Further, additional components commonly associated with such separation devices, such as baffles and additional flow control mechanisms, or other conduit sections for added flow redirection capabilities, may be incorporated and/or interposed between described segments, and/or omitted, without departing from the spirit of the present inventive concepts.

Still further, in some embodiments, the surfaces that define the separation compartment may be defined by walls other than those that also define the exterior of the device, without departing from the spirit of the present inventive concepts. For example, interior walls may be added to define the separation compartment that are spaced inwardly from exterior walls. Yet still further, the “exterior” of the device refers to all spaces outside of the separation compartment, and does not imply that the surrounding areas comprising the exterior are continuous, contiguous and/or similar to one another.

Furthermore, directional references (e.g., top, bottom, front, back, up, down, etc.) are used herein solely for the sake of convenience and should be understood only in relation to each other. For instance, a component might in practice be oriented such that faces referred to as “top” and “bottom” are sideways, angled, inverted, etc. relative to the chosen frame of reference.

It is also noted that, as used herein, the terms axial, axially, and variations thereof mean the defined element has at least some directional component along or parallel to the axis. These terms should not be limited to mean that the element extends only or purely along or parallel to the axis. For example, the element may be oriented at a forty-five degree (45° angle relative to the axis but, because the element extends at least in part along the axis, it should still be considered axial. Similarly, the terms radial, radially, and variations thereof shall be interpreted to mean the element has at least some directional component in the radial direction relative to the axis.

It is farther noted that the term annular shall be interpreted to mean that the referenced object extends around a central opening so as to be generally toroidal or ring-shaped. It is not necessary for the object to be circular, nor does the object have to be continuous. Similarly, the term toroidal shall not be interpreted to mean that the object must be circular or continuous.

It should still farther be noted that, in one construction, the separation device is molded from high density polyethylene to inhibit corrosion and leaking. In other constructions, the container can be formed from other suitable materials using any suitable method.

The preferred forms of the invention described above are to be used as illustration only and should not be utilized in a limiting sense in interpreting the scope of the present inventive concepts. Obvious modifications to the exemplary embodiments, as hereinabove set forth, could be readily made by those skilled in the art without departing from the spirit of the present inventive concepts.

The inventors hereby state their intent to rely on the Doctrine of Equivalents to determine and assess the reasonably fair scope of the present inventive concepts as pertains to any apparatus not materially departing from but outside the literal scope of the invention set forth in the following claims.

1. A field-adjustable separation device comprising:
a base and a sidewall cooperatively defining a separation compartment;
an inlet conduit attached to a first portion of the sidewall; and
an outlet conduit having
a first segment including a distal end of the outlet conduit removably attached to a second portion of the sidewall substantially opposite the first portion;
a second segment fluidly interposed between the first segment and the separation compartment, the second segment including a sectioned portion defining a plurality of pre-determined locations spaced along the second segment;
wherein,
the first segment is in fluid communication with an exterior of the separation compartment,
the second segment is configured for adjustment to define an outlet orifice according to the plurality of pre-determined locations to provide fluid communication between the first segment and the separation compartment,
the adjustment alternatively presenting the outlet orifice at a different distance from the distal end for each of the plurality of pre-determined locations, as measured along a vertical axis.

2. The device of claim 1, wherein,
the second segment includes a stem detachably coupled to an end piece,
the stem includes the sectioned portion,
the end piece defines the outlet orifice and is configured for adjustment along the stem alternatively to each of the plurality of pre-determined locations.

3. The device of claim 2, wherein:
the sectioned portion includes a plurality of seating structures spaced along an outer surface near a proximal end of the outlet conduit,
the end piece includes a mating structure,
the plurality of seating structures are configured for receiving the mating structure of the end piece.

4. The device of claim 3, wherein:
each of the plurality of seating structures includes a tab,
the mating structure includes a slot configured to alternatively receive each of the tabs.

5. The device of claim 1, wherein,
the first segment includes a snout,
the device includes a saddle, the saddle being fixed relative to the second portion of the sidewall,
the snout is removably attached to the saddle.

6. The device of claim 3, the sectioned portion including a plurality of indentations spaced along the outer surface, with each of the plurality of indentations corresponding to one of the plurality of seating structures.

7. The device of claim 1, the sectioned portion including a plurality of indentations spaced along an outer surface, with each of the plurality of indentations corresponding to one of the plurality of pre-determined locations.

8. The device of claim 1,
the inlet conduit including
a first segment including a distal end of the inlet conduit removably attached to the first portion of the sidewall;
a second segment fluidly interposed between the first segment and the separation compartment, the second segment including a sectioned portion defining a plurality of pre-determined locations spaced along the second segment;
wherein,
the first segment of the inlet conduit is in fluid communication with the exterior of the separation compartment,
the second segment of the inlet conduit is configured for adjustment to define an inlet orifice according to the plurality of pre-determined locations of the inlet conduit to provide fluid communication between the first segment of the inlet conduit and the separation compartment,
the adjustment of the inlet conduit alternatively presenting the inlet orifice at a different distance from the distal end of the inlet conduit for each of the plurality of pre-determined locations along the inlet conduit, as measured along the vertical axis,
the plurality of pre-determined locations of the inlet conduit substantially correspond to the plurality of pre-determined locations of the outlet conduit,
the device is configured so that the adjustment of the inlet conduit and the outlet conduit present the inlet orifice and the outlet orifice at substantially similar elevations in an assembled configuration.

9. A method for field adjustment of a separation device having a base and a sidewall cooperatively defining a separation compartment and an inlet conduit attached to a first portion of the sidewall, the method comprising:
removing an outlet conduit of the device, the outlet conduit including
a first segment including a distal end of the outlet conduit configured for removable attachment to a second portion of the sidewall substantially opposite the first portion;
a second segment fluidly interposed between the first segment and the separation compartment, the second segment including a sectioned portion defining plurality of pre-determined locations spaced along the second segment;
the second segment being configured for adjustment to define an outlet orifice according to the plurality of pre-determined locations to provide fluid communication between the first segment and the separation compartment;
adjusting the second segment to define the outlet orifice according to a first location of the plurality of pre-determined locations, the outlet orifice being at a first distance along a vertical axis from the distal end of the outlet conduit; and
reattaching the distal end of the adjusted outlet conduit to the second portion of the sidewall.

10. The method of claim 9, wherein:
the second segment includes a stem detachably coupled to an end piece defining the outlet orifice,
the stem includes the sectioned portion,
the adjustment includes moving the end piece along the stem to the first location.

11. The method of claim 10, wherein:
the sectioned portion includes a plurality of seating structures spaced along an outer surface near a proximal end of the outlet conduit,
the end piece includes a mating structure,
the plurality of seating structures are configured for receiving a mating structure of the end piece,
the adjustment includes aligning the mating structure to a first seating structure of the plurality of seating structures corresponding to the first location.

12. The method of claim 11, wherein:
each of the plurality of seating structures includes a tab,
the mating structure includes a slot configured to alternatively receive each of the tabs.

13. The method of claim 9, further comprising:
removing the inlet conduit, the inlet conduit including:
a first segment including a distal end of the inlet conduit configured for removable attachment to the first portion of the sidewall;
a second segment fluidly interposed between the first segment and the separation compartment, the second segment including a sectioned portion defining a plurality of pre-determined locations spaced along the second segment;
the second segment being configured for adjustment to define an inlet orifice according to the plurality of pre-determined locations to provide fluid communication between the first segment and the separation compartment;
adjusting the second segment of the inlet conduit to define the inlet orifice according to a first location of the plurality of pre-determined locations of the inlet conduit, the inlet orifice being at a first distance along a vertical axis from the distal end of the inlet conduit; and
reattaching the distal end of the adjusted inlet conduit to the first portion of the sidewall;
wherein, in an assembled configuration following reattachment of the inlet conduit and the outlet conduit, the inlet orifice and the outlet orifice are at substantially similar elevations.

14. The method of claim 11, the sectioned portion including a plurality of indentations spaced along the outer surface, with each of the plurality of indentations corresponding to one of the plurality of seating structures, further including the following:
locating a first indentation of the plurality of indentations corresponding to the first location;
cutting along the first indentation to remove a portion of the stem.

15. The method of claim 9, the sectioned portion including a plurality of indentations spaced along an outer surface, with each of the plurality of indentations corresponding to one of the plurality of pre-determined locations, further including the following:
locating a first indentation of the plurality of indentations corresponding to the first location;
wherein adjusting the second segment to define the outlet orifice includes cutting along the first indentation to remove a portion of the stem.

16. A field-adjustable outlet conduit for use with a separation device having a base and a sidewall cooperatively defining a separation compartment, the outlet conduit comprising:
a first segment including a distal end of the outlet conduit configured to be removably attached to the sidewall;
a second segment configured to be fluidly interposed between the first segment and the separation compartment, the second segment including a sectioned portion defining a plurality of pre-determined locations spaced along the second segment;
wherein,
the first segment is configured for fluid communication with an exterior of the separation compartment,
the second segment is configured for adjustment to define an outlet orifice according to the plurality of pre-determined locations to provide fluid communication between the first segment and the separation compartment,
the adjustment alternatively presents the outlet orifice at a different distance from the distal end for each of the plurality of pre-determined locations, as measured along a vertical axis in an assembled configuration of the separation device.

17. The outlet conduit of claim 16, wherein,
the second segment includes a stem detachably coupled to an end piece,
the stem includes the sectioned portion,
the end piece defines the outlet orifice and is configured for adjustment along the stem alternatively to each of the plurality of pre-determined locations.

18. The device of claim 17, wherein:
the sectioned portion includes a plurality of seating structures spaced along an outer surface near a proximal end of the outlet conduit,
the end piece includes a mating structure,
the plurality of seating structures are configured for receiving the mating structure of the end piece.

19. The device of claim 18, the sectioned portion including a plurality of indentations spaced along the outer surface, with each of the plurality of indentations corresponding to one of the plurality of seating structures.

20. The device of claim 16, the sectioned portion including a plurality of indentations spaced along an outer surface, with each of the plurality of indentations corresponding to one of the plurality of pre-determined locations.
